(19) United States
(12) Patent Application Publication
(10) Pub. No.: US 2024/0406986 A1
(43) Pub. Date: Dec. 5, 2024

(54) METHOD FOR ESTIMATING A NUMBER OF VEHICLES IN COMMUNICATION WITH A SATELLITE

(71) Applicant: CONTINENTAL AUTOMOTIVE TECHNOLOGIES GMBH, Hannover (DE)

(72) Inventors: Emmanuel PASQUET, Frouzins (FR); Mohamed CHEIKH, Toulouse (FR); Sébastien KESSLER, Drémil - lafage (FR)

(21) Appl. No.: 18/688,862

(22) PCT Filed: Sep. 5, 2022
(86) PCT No.: PCT/EP2022/074560

§ 371 Date: Mar. 4, 2024

(30) Foreign Application Priority Data
Sep. 21, 2021 (FR) FR2109918

(51) Int. Cl. H04W 72/51; H04W 52/02; H04W 72/044; H04W 84/06

(52) U.S. Cl. CPC H04W 72/51; H04W 52/0206; H04W 72/044; H04W 84/06

(57) ABSTRACT

A method for estimating a number of vehicles present within an area of visibility of an LEO satellite that consumes little energy for the LEO satellite and that is compact in terms of bandwidth.

### CROSS REFERENCE TO RELATED APPLICATIONS

This application is the U.S. National Phase Application of PCT International Application No. PCT/EP2022/074560, filed Sep. 5, 2022, which claims priority to French Application No. 2109918, filed Sep. 21, 2021, the contents of such applications being incorporated by reference herein.

### FIELD OF THE INVENTION

The present invention relates to a method for estimating a number of vehicles in communication with a determined satellite.

### BACKGROUND OF THE INVENTION

In a communication network, it is important to know the number of registered users in order to determine the bandwidth required for the various services to which the users have subscribed in order to ensure a homogeneous quality of service level or to direct network capacity to priority services, such as emergency numbers for example.

At present, this step is carried out for a 3G/4G/5G cellular network by registering the user on a base station by way of protocol exchanges on signaling channels. To this end, the mobile terminal (user) and the base station periodically (several times per second) exchange signaling and synchronization frames in order to ascertain the topology of the network, of the adjacent cells and the distance between the user and the base station.

These protocol exchanges are energy-consuming for the terminal and the base station and consume a significant portion of the bandwidth simply to ascertain the number of users present within the area of coverage of the base station.

If the base station is a low Earth orbit satellite (or LEO satellite) and the users are vehicles, the satellite covers areas with a size of the order of magnitude of a country such as France, and therefore has to estimate a number of users potentially comprising several million vehicles. The energy available on LEO satellites is limited since they are powered by solar energy, and there are fewer frequency bands allocated for exchanges with users than in the case of cellular networks.

In this regard, it is not conceivable to register a user (vehicle) with an LEO satellite (base station) using signaling channels, not least due to the aspects of energy consumption of the satellite and bandwidths allocated to the various signaling exchanges, the LEO satellite potentially having to carry out exchanges with several million vehicles.

An aspect of the invention aims to improve this situation.

### SUMMARY OF THE INVENTION

One aim of an aspect of the present invention therefore consists in proposing a method for estimating a number of vehicles present within an area of visibility of a low Earth orbit, LEO, satellite, the LEO satellite being designed to receive presence signals from vehicles, the method being implemented by a computer on board the LEO satellite and being characterized in that it comprises:
incrementing a presence counter for each reception of a presence signal from a vehicle located within the area of visibility of the LEO satellite, and
estimating the number of vehicles present within the area of visibility of the LEO satellite based on the presence counter based on a transmission frequency of the presence signals and on a duration of visibility of the LEO satellite associated with the area of visibility, the duration of visibility corresponding to a time interval during which the satellite receives presence signals from its associated area of visibility and based on the presence counter by using a sliding average method that considers the transmission frequency of the vehicles and the duration of visibility of the satellite.

Optionally, a presence signal corresponds to an electromagnetic wave transmitted by a vehicle comprising a particular signature enabling the computer of the satellite to determine that a vehicle is involved in order to increment its counter.

Optionally, a particular vehicle signature also enables the computer of the satellite to determine a characteristic of said vehicle.

Optionally, the particular signature of the electromagnetic wave comprises at least one element characterizing it from among a wavelength of the electromagnetic wave, a frequency of the electromagnetic wave, a type of modulation of the electromagnetic wave or a binary sequence.

Optionally, the method furthermore comprises adding a margin of error to the estimated number of vehicles.

Optionally, the method also comprises determining a bandwidth associated with a transmission of data between the LEO satellite and vehicles present within its area of visibility on the basis of the estimation of the number of vehicles present within this area of visibility.

Optionally, the method comprises, beforehand, transmitting a request for a data transfer from the satellite to vehicles present within its area of visibility, and characterized in that an ability sub-counter of the presence counter is incremented when a presence signal characteristic of an ability to receive the data transfer is received by the LEO satellite.

Optionally, the method furthermore comprises transmitting a plurality of items of information from the LEO satellite to a ground station, the plurality of items of information being determined based on the presence signals.

An aspect of the invention also presents a method for controlling a satellite from a ground station, so that an LEO satellite implements one of the methods presented by the present application.

An aspect of the invention furthermore protects a computer comprising program code instructions for commanding the execution of any one of the methods presented by the present application.

An aspect of the invention also relates to a computer program product comprising instructions for implementing any one of the methods presented by the present application when this method is implemented by a computer.

Finally, an aspect of the invention relates to a non-transient computer-readable storage medium storing code instructions for implementing any one of the methods presented by the present application.

An aspect of the invention therefore makes it possible to estimate a number of vehicles within an area of visibility of a satellite even if several million vehicles are present within this area, without using all of the frequency bands allocated to the satellite. The energy devoted to this estimation at the satellite is low due to the small amount of computing resources required from the computer to detect and process the presence signals.

Moreover, in some advantageous options, an aspect of the invention makes it possible to optimize and/or prioritize the communications transmitted by the satellite on the basis of the number of vehicles estimated, for example on the basis of intrinsic characteristics of certain vehicles, in order to manage driving safety aspects in particular. Some options also make it possible to determine a bandwidth associated with a transmission of data on the basis of the number of vehicles, thereby potentially making it possible for example to determine whether this transmission of data is feasible in the frequency band allocated to the satellite. In some options, an aspect of the invention also makes it possible to manage the transmission of data streams, for example by transmitting information acquired by the satellite to a base station, which may use this information or retransmit it to other satellites.

### BRIEF DESCRIPTION OF THE DRAWINGS

Other features, details, aspects, and advantages will become apparent from reading the following detailed description and from examining the appended drawings, in which:

FIG. 1 shows one example of a communication architecture.

FIG. 2 shows one example of a low Earth orbit satellite.

FIG. 3 shows one example of a method for estimating a number of vehicles present within an area of visibility of a low Earth orbit satellite.

### DETAILED DESCRIPTION OF THE PREFERRED EMBODIMENTS

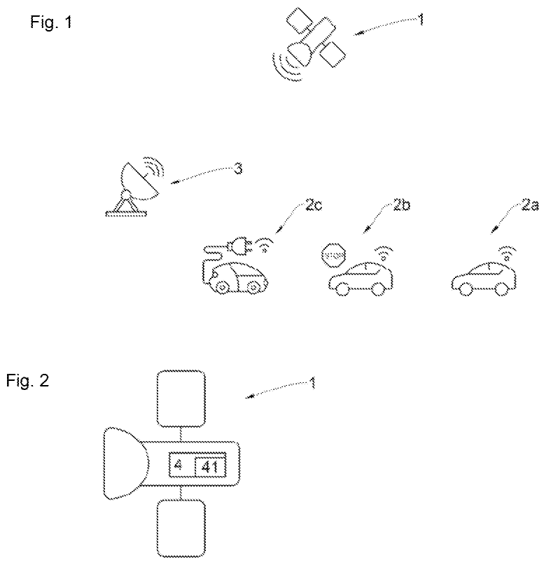

Reference is now made to FIG. 1, showing one example of a communication architecture in which the various methods presented by the present application are able to be implemented.

The exemplary communication architecture that is shown comprises a low Earth orbit, LEO, satellite 1, a plurality of vehicles 2, and may comprise a ground station 3.

An LEO satellite should be understood, in the present application, as being a satellite moving in the low Earth orbit, that is to say moving at an altitude of up to 2000 kilometers.

The plurality of vehicles 2 and the ground station 3 are contained within an area of visibility of the LEO satellite. The area of visibility of the LEO satellite is defined as the portion of the Earth's surface within which the LEO satellite is able to exchange communication signals with various entities, for example send or receive data. In this case, since an LEO satellite is in orbit around the Earth, the area of visibility that it covers represents a surface area on the ground of the order of 2700 to 1 000 000 km², and this area moves as the satellite moves. The number of entities contained within this area and with which the satellite is able to communicate therefore changes over time.

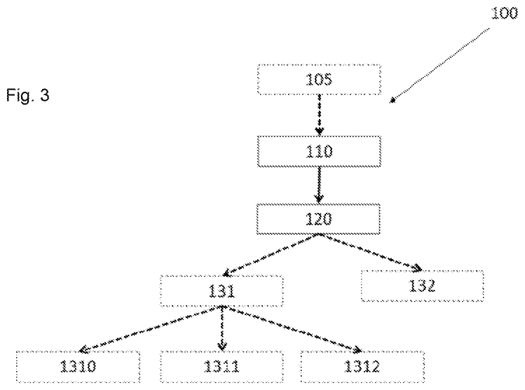

With reference to FIG. 2, one example of an LEO satellite 1 comprises a computer 4 and a memory 41. The computer 4 may for example be a processor or a microcontroller. It comprises access to the memory 41, such that it is able to use the information contained therein. The computer 4 is designed to execute code instructions enabling implementation of a method. In particular, the computer 4 is designed in particular to execute code instructions enabling implementation of a method for estimating a number of vehicles present within the area of visibility of the LEO satellite, one example of which is presented with reference to FIG. 3.

The memory 41 may for example comprise a ROM (read-only memory), a RAM (random access memory), an EEPROM (electrically erasable programmable read-only memory) or any other type of suitable storage means enabling in particular code instructions to be read. The memory may for example comprise optical, electronic or else magnetic storage means. The memory 41 may for example comprise code instructions for implementing any one of the methods described by the present disclosure.

As an alternative or in addition, the satellite may also comprise remote communication means for communicating for example with vehicles 2 and/or with the ground station 3. These remote communication means comprise for example a radiofrequency-wave transceiver. In particular, they enable the satellite to receive control instructions from the ground station in order to implement the method described below.

With reference to FIG. 3, one example of a method 100 for estimating a number of vehicles present within the area of visibility of the LEO satellite 1 is described below.

As illustrated by block 110, the method 100 comprises incrementing a presence counter for each reception of a presence signal from a vehicle located within the area of visibility of the LEO satellite.

The presence counter is advantageously initialized at a value of zero. It may comprise multiple presence sub-counters and be the result of a sum of all or some of its sub-counters. The presence counter, and the sub-counters where applicable, may thus be stored in the memory 41 of the LEO satellite.

A presence signal from a vehicle may correspond to an electromagnetic wave transmitted by the vehicle, for example a radiofrequency wave, the electromagnetic wave comprising a particular signature enabling the computer 4 of the satellite to determine that a vehicle 2 is involved. In this way, the computer 4 is able to increment the presence counter upon reception of the presence signals.

In some examples, a particular signature of the electromagnetic wave comprises at least one element characterizing it from among a wavelength of the electromagnetic wave, a frequency or a frequency range of the electromagnetic wave, a type of modulation of the electromagnetic wave or a binary sequence.

The LEO satellite is therefore designed to detect electromagnetic waves comprising particular signatures so as to be able to count the vehicles present within its area of visibility, a received wave having said particular signature corresponding to a vehicle to be counted.

In some embodiments, each vehicle transmits a presence signal at a determined transmission frequency that makes it possible, as indicated below, to deduce therefrom the number of vehicles within the area of visibility of the satellite at a given time. The transmission frequency may be the same for all vehicles in order to simplify the deduction of the number of vehicles within the area of visibility.

As a variant, each vehicle transmits a presence signal in response to a request sent beforehand by the satellite, the request being transmitted for example by being broadcast over its entire area of visibility.

When the electromagnetic wave comprises a binary sequence, the computer 4 of the satellite is designed to decode the binary sequence and determine whether the electromagnetic wave actually corresponds to a presence signal from a vehicle. Advantageously, the binary sequence is small so as to enable the computer 4 to perform fast decoding and to reduce the bandwidth of the electromagnetic wave. A binary sequence of an electromagnetic wave coding for a vehicle may for example comprise between 8 and 64 bytes.

It will be understood here that the energy consumed by the LEO satellite (and more precisely by its computer 4) to determine that a vehicle is present within its area of visibility is very low compared to what would be used by the exchange of signaling frames, as is carried out in cellular networks. The same applies to the bandwidth used to determine the presence of a vehicle within the area.

In some examples, a particular signature of the presence signal from the vehicle may also enable the computer 4 of the satellite 1 to determine a characteristic of said vehicle. A characteristic of a vehicle 2 may be for example a traffic status of the vehicle, a vehicle model, a vehicle make, or an ability of the vehicle to receive a determined data transfer.

In this case, a vehicle may be associated with multiple characteristics that it is able to communicate to the satellite by way of a particular signature of the electromagnetic wave. The computer 4 may thus increment a sub-counter of the presence counter associated with at least one characteristic of the vehicle that it determines based on the particular signature. A first sub-counter may for example be associated with a first make, and a second sub-counter may be associated with a second make.

A particular signature of a characteristic of a vehicle may for example comprise a specific wavelength of the electromagnetic wave, a specific frequency or a specific frequency range of the electromagnetic wave, a specific type of modulation of the electromagnetic wave or a specific binary sequence. It is also conceivable for a presence signal from a vehicle to be able to comprise a combination of these elements in order to communicate multiple characteristics.

With regard to the traffic statuses, FIG. 1 shows for example a vehicle 2a having an “in traffic” traffic status, that is to say the vehicle 2a is traveling on the road network within the area of visibility of the LEO satellite when it sends a presence signal to said LEO satellite. The “in traffic” traffic status may for example be communicated to the satellite by a presence signal from the vehicle 2a having a first type of signature, for example the signal being within a first frequency range.

Also shown is a vehicle 2b having a “stationary” traffic status, that is to say the vehicle 2b has been stationary for at least a predetermined stationary time interval when it sends its presence signal to the LEO satellite. The predetermined stationary time may for example be between around ten seconds and around ten minutes, and preferably between two and five minutes. The “stationary” traffic status may for example be communicated to the satellite by a presence signal from the vehicle 2b having a second type of signature, for example the signal being within a second frequency range.

Shown last is a vehicle 2c having a “charging” traffic status, that is to say that the vehicle 2c is an electric vehicle in the phase of charging its batteries, when it sends its presence signal to the LEO satellite. The “charging” traffic status may for example be communicated to the satellite by a presence signal from the vehicle 2c having a third type of signature, for example the signal being within a third frequency range.

Thus, in the example shown, the particular signature of the electromagnetic wave of the presence signals from the vehicles 2a, 2b and 2c may be different, such that the computer 4 of the satellite is capable of identifying this signature as belonging to vehicles 2 in a different traffic status. In one example, the computer 4 may increment a sub-counter associated with a predetermined traffic status on the basis of the traffic status that it identifies upon reception of a presence signal.

As illustrated by block 120, the method 100 comprises estimating the number of vehicles present within the area of visibility of the LEO satellite based on the presence counter.

In some embodiments in which the vehicles transmit presence signals regularly at a given transmission frequency, this estimation is carried out based on the presence counter, on a transmission frequency of the presence signals and on a duration of visibility of the LEO satellite associated with the area of visibility.

The duration of visibility corresponds to a time interval during which the satellite receives presence signals from its associated area of visibility. In this case, since the LEO satellite is moving, it will cover a determined area of visibility only during a determined time interval. In this regard, taking into account the duration of visibility and the transmission frequency of the presence signals from the vehicles present makes it possible to estimate the number of vehicles within the determined area of visibility based on the presence counter.

For example, assuming a transmission frequency of the presence signals of one presence signal per minute for vehicles and a duration of visibility of ten minutes for an area of visibility, one and the same vehicle present within the area will transmit on average around ten presence signals. The presence counter will therefore be incremented around ten times for each vehicle within the area of visibility when the satellite has been covering the area for ten minutes. An estimation of the number of vehicles within the area of visibility may therefore correspond to the value of the presence counter divided by ten.

In cases in which various vehicles or types of vehicles transmit presence signals at different transmission frequencies, the transmission frequency of the presence signals that is used by the satellite to estimate the number of vehicles within the area of visibility may for example correspond to an average of the transmission frequencies of a presence signal from multiple vehicles, from multiple vehicle models or from multiple vehicle makes.

As an alternative, vehicles corresponding to various categories may transmit presence signals at different transmission frequencies, the presence signals comprising a signature specific to each category. The number of vehicles may then be determined category by category.

In some embodiments, the number of vehicles within the area of visibility may be estimated based on the presence counter by using a sliding average method, considering the transmission frequency of the vehicles and the duration of visibility of the satellite. An aspect of the present invention uses the term “sliding average method” to denote a method for updating the value of the presence counter on the basis of a movement of the area of visibility of the satellite, that is to say for eliminating incrementations corresponding to vehicles considered to no longer form part of the area of visibility of the satellite. Eliminating an incrementation of the presence counter corresponds to decrementing the presence counter once.

In a sliding average method, the presence counter may comprise a number x of sliding average presence sub-counters, x being a natural integer. Each sliding average presence sub-counter has associated therewith a sliding average timer (which may be the same one shared between the sliding average sub-counters), the presence sub-counters being incremented to count presence signals detected successively when their associated timer is running. In this case, only the sliding average presence sub-counter the sliding average timer of which is running is incremented upon reception of the presence signals, such that the sliding average presence sub-counters are not incremented simultaneously upon reception of one and the same presence signal. Thus, when the sliding average timer of a first presence sub-counter is terminated, a timer associated with another presence sub-counter is started (or restarted if the same timer is involved) and the sliding average counter is itself incremented upon reception of the presence signals, as long as its associated timer has not reached a threshold value. When all of the sliding average presence sub-counters have been incremented, one of the sliding average presence sub-counters is reset and re-incremented upon reception of the presence signals for the duration of its timer, and then it is the turn of another to be reset and then re-incremented for the duration of its timer, etc. In this way, the sum of the x sliding average presence counters corresponds to all of the presence signals received for a duration corresponding to x multiplied by the threshold value of the timer. This sum thus takes into consideration the movement of the satellite (and therefore the movement of the area of visibility of the satellite) by successively resetting the sub-counters to 0.

The threshold value of the sliding average timer and the number x of sliding average presence sub-counters may for example be determined based on the duration of visibility of the satellite. In one example, the number x of sub-counters multiplied by the duration of the sliding average timer is equal to the duration of visibility of the satellite. Thus, dividing the sum of the sliding average presence sub-counters by the ratio between the duration of visibility of the satellite and the transmission frequency of the vehicles gives an estimate of the number of vehicles within the area of visibility, which is updated with the movement of the satellite. Moreover, the higher the number x of sliding average presence sub-counters, the more frequently the estimate of the number of vehicles within the area of visibility is updated. It will therefore be understood that, based on a transmission frequency of the presence signals from the vehicles, on a duration of visibility of an associated area of visibility and on the presence counter, the computer 4 of the satellite is able to estimate the number of vehicles present within the area of visibility.

This is an embodiment implementing a sliding average based on x sub-counters and at least one timer (at most x timers). This embodiment is particularly advantageous insofar as it consumes little energy and little memory space, since it involves only incrementing the sub-counters and the at least one timer and resetting them to 0. However, it will be understood that other sliding average methods for the presence counter that are more expensive in terms of energy and memory space may be implemented.

In one alternative example, a sliding average method may comprise association, for each incrementation of the presence counter, of a predetermined duration of existence and, when the duration of existence associated with an incrementation has elapsed, decrementation of the presence counter. In one example, the duration of existence is equal to the duration of visibility of the satellite. In another example, the duration of existence is equal to the transmission frequency of the vehicles. In this other example, it is therefore no longer necessary to divide the presence counter by the ratio between the duration of visibility and the transmission frequency of the vehicles. Although this alternative sliding average method is more precise, it requires triggering as many timers as there are presence signals detected during the duration of existence, and therefore a greater cost in terms of energy and memory impact at the LEO satellite.

Moreover, the computer 4 may also estimate the number of vehicles having a determined characteristic that are present within the area of visibility insofar as these vehicles send presence signals comprising this information via their signature and the computer is capable of detecting this using the same method.

Thus, the method, insofar as it uses presence signals from vehicles that require little bandwidth, makes it possible to be able to estimate the number of vehicles within an area of visibility of a satellite even if several million vehicles are present within this area, without using all of the frequency bands allocated to the satellite, which are narrower than the frequency bands available for terrestrial communications. Moreover, since the presence signals are detected and processed by the computer 4 of the satellite with few computing resources in order to estimate the number of vehicles present within the area of visibility, the energy of the satellite devoted to this task remains low. The presented method therefore makes it possible in particular to estimate a very large number of vehicles present within an area of visibility of a satellite while using both little bandwidth and little energy at the satellite. By comparison, the use of signaling frames, as carried out in cellular networks, to determine a number of users present within an area of visibility of the satellite would devote the majority of the energy and bandwidth resources of the LEO satellite to this task.

Consequently, the estimation of the number of vehicles within the area of visibility of the satellite may be used to optimize and/or prioritize the communications transmitted by the satellite on the basis of the number of vehicles counted. The method presented above with reference to FIG. 3, and in particular blocks 110 and 120, may therefore constitute part of a wider method for communication between the LEO satellite and vehicles present within the area of visibility. In this regard, the blocks shown in dotted lines in FIG. 3 represent optional additions to the method.

Thus, in some examples, the method may comprise, beforehand, transmitting a request for a data transfer from the satellite to vehicles present within its area of visibility. This transmission, represented by block 105, may be a broadcast transmission, that is to say one directed to all of the vehicles within the area of visibility. The vehicles able to receive the data transfer associated with the request may respond to the request from the satellite with a presence signal comprising a particular signature characteristic of their ability to receive the data transfer. One particular signature characteristic of an ability to receive the data transfer may comprise a characteristic wavelength of the electromagnetic wave, a characteristic frequency of the electromagnetic wave, a characteristic type of modulation of the electromagnetic wave or a characteristic binary sequence. An ability sub-counter of the presence counter may thus be incremented in order to estimate the number of vehicles able to receive this data transfer upon reception of a presence signal comprising this particular characteristic signature.

In some examples, the method may also comprise determining a bandwidth associated with a transmission of data between the LEO satellite and vehicles present within its area of visibility on the basis of the estimation of the number of vehicles present within this area of visibility. This determination is represented by block 131 in FIG. 3.

Determining the bandwidth associated with the transmission of data from the LEO satellite may correspond to dividing the available bandwidth by the number of vehicles estimated within the area of visibility.

The method may furthermore comprise selecting a type of communication to be transmitted, and transmitting data from the LEO satellite to vehicles present within its area of visibility according to this type of communication, on the basis of the determined associated bandwidth. This is block 1310 in FIG. 3. In particular, the method may comprise a transmission of data directed to vehicles associated with at least one predetermined traffic status. For example, for a transmission of data corresponding to an update of the driving functions of the vehicle, insofar as aspects of passenger safety are to be considered, the transmission may be directed only to vehicles in “stationary” or “charging” traffic statuses. In this regard, determining the bandwidth associated with the transmission of data may comprise dividing the available bandwidth by the number of vehicles, in the at least one predetermined traffic status, estimated within the area.

Furthermore, determining the bandwidth associated with a transmission of data may make it possible to discern that the transmission of data cannot be carried out to all vehicles present within the area. The method may thus comprise selecting a group of determined vehicles present within the area of visibility and transmitting data to this group of determined vehicles. This is block 1311 in FIG. 3. This makes it possible for example to select a group of priority vehicles. As an alternative or in addition to the selection of a group of vehicles, the method may also comprise modifying the transmission of data so as to adapt to the available bandwidth. This modification of the transmission is represented by block 1312 in FIG. 3.

In some examples, the method may furthermore comprise adding a margin of error to the estimated number of vehicles. Indeed, this margin of error may be used to compensate for presence signals that are not detected by the computer 4, for example in the case of reception of a non-interpretable superposition of signals. This margin of error makes it possible for example to avoid a determination of the bandwidth associated with a transmission of data that is too large with respect to the associated bandwidth as soon as the number of vehicles present within the area of visibility has been underestimated. This addition (not shown in the figure) may therefore advantageously be carried out prior to block 131. In some examples, the added margin of error may be between 1 and 30% and preferably between 10 and 20% of the number of vehicles estimated.

In some examples, the method may furthermore comprise the LEO satellite transmitting a plurality of items of information to the ground station 3. This is block 132 in FIG. 3. The plurality of items of information may be determined based on the presence signals. The plurality of items of information may for example comprise the number of vehicles estimated within the area of visibility, the number of vehicles estimated as being present within the area and being associated with at least one predetermined characteristic, a bandwidth associated with a transmission of data. It will be understood that block 131 and the following blocks may therefore be combined with block 132. The plurality of items of information may also comprise information about vehicles present within the area, such as an identifier or a location of a vehicle. This makes it possible for example to communicate this information to another LEO satellite via the ground station 3, acting as a relay that is able to use said information directly. Indeed, and as stated above, since the LEO satellite is moving, the information relating to the vehicles present within an area of visibility becomes obsolete for said satellite. On the other hand, said information may be used by another LEO satellite flying over the area later, the LEO satellites being able for example to operate in the form of a constellation of satellites. The ground station 3 may therefore serve as a relay for relaying information between various LEO satellites, whether or not they belong to one and the same constellation of satellites.

The methods according to aspects of the invention therefore make it possible to statistically estimate, using little energy for the computer of the LEO satellite and inexpensively in terms of bandwidth, a very large number of vehicles present within an area of visibility of the LEO satellite. This makes it possible in particular to avoid devoting a large portion of the available bandwidth and of the energy available at the satellite to registering and updating vehicles with the satellite. Some exemplary embodiments of the method use this estimation in particular to determine an available bandwidth for a transmission of data to vehicles. An aspect of the invention is therefore extremely advantageous in the context of the circulation of autonomous vehicles in constant demand for information about their environment, these data having to be sent in particular by an LEO satellite. Moreover, the clever use of a presence signal comprising a particular signature requiring little processing by the computer 4 of the satellite makes it possible both to estimate the number of vehicles present within an area of visibility and to integrate relevant characteristics of the vehicles for a subsequent data transfer. This makes it possible in particular to prioritize certain data transfers or to propose data transfers that are more specific to the vehicles present within the area, in particular with regard to their model or their make, with security updates for example. Other exemplary embodiments of the method also make it possible to transfer data acquired by an LEO satellite over an area of visibility to a ground station, for example so that these data are able to be sent back to another LEO satellite that has to fly over this area of visibility and that will be able to use them.

The present application also relates to a method for controlling a satellite from the ground station 3, so that an LEO satellite implements any one of the methods presented above. In this sense, the ground station 3 may also comprise a computer and a memory, the memory comprising code instructions enabling the computer of the ground station 3 to implement the method for controlling the satellite.

In one embodiment, the method for controlling the satellite may correspond to a control method intended directly for the LEO satellite, so that the LEO satellite implements any one of the methods presented above.

In one alternative embodiment, the method for controlling the satellite may correspond to a control method intended for a satellite located further from the Earth than the LEO satellite, so that this satellite located further away controls the LEO satellite so as to implement any one of the methods presented above. The satellite located further away therefore acts as an intermediary between the ground station and the LEO satellite.

In some examples, a satellite located further away than the LEO satellite may correspond to a medium Earth orbit, MEO, satellite or a geostationary satellite. The present application uses the term “MEO satellite” to denote a satellite moving in medium Earth orbit, that is to say moving at an altitude of between 2000 kilometers and around 36000 kilometers. The present application uses the term “geostationary satellite” to denote a satellite moving in a geostationary orbit.

1. A method for estimating a number of vehicles present within an area of visibility of a low Earth orbit, LEO, satellite, the LEO satellite being designed to receive presence signals from vehicles, the method being implemented by a computer on board the LEO satellite, the method comprising:
incrementing a presence counter for each reception of a presence signal from a vehicle located within the area of visibility of the LEO satellite, and
estimating the number of vehicles present within the area of visibility of the LEO satellite based on a transmission frequency of the presence signals and on a duration of visibility of the LEO satellite associated with the area of visibility, the duration of visibility corresponding to a time interval during which the satellite receives presence signals from its associated area of visibility and based on the presence counter by using a sliding average method that considers the transmission frequency of the vehicles and the duration of visibility of the satellite.

2. The method as claimed in claim 1, wherein a presence signal corresponds to an electromagnetic wave transmitted by a vehicle comprising a particular signature enabling the computer of the satellite to determine that a vehicle is involved in order to increment its counter.

3. The method as claimed in claim 2, wherein a particular vehicle signature also enables the computer of the satellite to determine a characteristic of said vehicle.

4. The method as claimed in claim 2, wherein the particular signature of the electromagnetic wave comprises at least one element characterizing it from among a wavelength of the electromagnetic wave, a frequency of the electromagnetic wave, a type of modulation of the electromagnetic wave or a binary sequence.

5. The method as claimed in claim 1, wherein the method furthermore comprises adding a margin of error to the estimated number of vehicles.

6. The method as claimed in claim 1, wherein the method also comprises determining a bandwidth associated with a transmission of data between the LEO satellite and vehicles present within its area of visibility on the basis of the estimation of the number of vehicles present within this area of visibility.

7. The method as claimed in claim 1, wherein the method comprises, beforehand, transmitting a request for a data transfer from the satellite to vehicles present within its area of visibility, and wherein an ability sub-counter of the presence counter is incremented when a presence signal characteristic of an ability to receive the data transfer is received by the LEO satellite.

8. The method as claimed in claim 1, wherein the method furthermore comprises transmitting a plurality of items of information from the LEO satellite to a ground station, the plurality of items of information being determined based on the presence signals.

9. A method for controlling a satellite from a ground station, so that an LEO satellite implements a method as claimed in claim 1.

10. A computer, comprising program code instructions for commanding the execution of a method as claimed in claim 1.

11. A computer program product comprising instructions for implementing the method as claimed in claim 1 when it is implemented by a computer.

12. A non-transient computer-readable storage medium storing code instructions for implementing a method as claimed in claim 1.
